(19) United States
(12) Patent Application Publication
(10) Pub. No.: US 2009/0083227 A1
(43) Pub. Date: Mar. 26, 2009

(54) RETRIEVING APPARATUS, RETRIEVING METHOD, AND COMPUTER PROGRAM PRODUCT

(75) Inventors: Miwako DOI, Kanagawa (JP); Kaoru SUZUKI, Kanagawa (JP); Toshiyuki KOGA, Kanagawa (JP); Koichi YAMAMOTO, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/041,283

(22) Filed: Mar. 3, 2008

(30) Foreign Application Priority Data
Sep. 25, 2007 (JP) 2007-247992

(51) Int. Cl. G06F 17/30

(52) U.S. Cl. 707/3; 707/E17.014

(57) ABSTRACT

A word coinciding with a retrieval object keyword and a word tied to the word are read out from a word dictionary in which words representing formal names and aliases of the normal names are registered in association with a family attribute indicating a family relation among the words. The keyword is expanded by reading out the words and content related to any one of the read words is retrieved.

### CROSS-REFERENCE TO RELATED APPLICATIONS

This application is based upon and claims the benefit of priority from the prior Japanese Patent Application No. 2007-247992, filed on Sep. 25, 2007; the entire contents of which are incorporated herein by reference.

### BACKGROUND OF THE INVENTION

1. Field of the Invention

The present invention relates to a retrieving apparatus, a retrieving method, and a computer program product for retrieving content related to a specific keyword.

2. Description of the Related Art

According to the spread of the broadband, television terminals with which it is possible to use video delivery services (Video On Demand: VOD) for movies and the like through the Internet are spreading. Television terminals including hard disk recorders and storage devices such as a hard disk are also spreading. Television terminals that can not only receive programs but also record the programs are appearing on the market. Besides the television terminals, audio video personal computers (AV-PCs) with high resolution for mainly viewing analog broadcasts and terrestrial digital broadcasts are started to spread. It is possible to record content materials such as received programs in hard disks.

A digital living network alliance (DLNA) guideline that makes it possible to mutually connect apparatuses such as the AV-PCs, the television terminals, and the hard disk recorders is decided. Users of apparatuses conforming to this guideline can view content materials (hereinafter, “contents”) recorded in all the apparatuses from the users' own apparatuses.

The users can view an extremely large number of contents as described above. However, in viewing specific content, the users need to retrieve the content desired to be viewed out of the large number of contents. In retrieval of content, in general, an electronic program guide (EPG) simultaneously recorded when contents are recorded is used. The EPG includes information concerning contents, for example, genres such as sports and news and performers. Therefore, it is possible to retrieve content based on these kinds of information.

Methods of operating the AV-PCs, the television terminals, and the hard disk recorders are becoming more complicated according to an increase in functions of the apparatuses. Therefore, an operation method employing speech recognition attracts attention. To retrieve content using speech recognition, “reading” of a word related to the content is necessary. Various technologies have been conventionally proposed as a technology for speech recognition.

For example, JP-A 2004-171174 (KOKAI) discloses a technology for reading out, when a user inputs readings of unknown words not registered yet, a sentence according to the readings. JP-A 2005-227545 (KOKAI) discloses a technology for using, when a reading kana is given to a word in an EPG, the reading kana as a reading of the word.

Forms of words tend to change with the use of the words. In particular, people are often called by aliases such as abbreviated names and nicknames as names of people are spoken in more opportunities.

Therefore, even when a program recorded in the past and a program presently broadcasted or a program to be broadcasted in future represent the same object, words representing the programs in an EPG can be different. For example, a name representing the same person, the same program title, or the like is described as a formal name in an EPG of programs in the past but is described in another name such as an abbreviated name or a nickname in an EPG of programs at present or in future. In the conventional retrieval technology employing an EPG, when a user tries to retrieve a program using an abbreviated name or a nickname that the user uses, even if the program is present, the user cannot retrieve the program because the program is represented by a name different from the abbreviated name of the nickname in the EPG. On the other hand, when an abbreviated name or a nickname is described in the EPG and the user tries to retrieve a program using a formal name, even if the program is present, the user cannot retrieve the program because the program is represented by the name different from the formal name in the EPG.

It is conceivable to solve the problems described above by manually registering abbreviated names and nicknames using the technology disclosed in JP-A 2004-171174 (KOKAI). However, operation for the registration is complicated because the user needs to register every abbreviated name and nickname. Moreover, when the user does not know readings of aliases such as abbreviated names and nicknames, the user cannot register the aliases.

In general, because the readings are given to only formal names in the EPG, the user cannot acquire readings of aliases of the formal names from the EPG. Therefore, even if the technology disclosed in JP-A 2005-227545 (KOKAI) is used, the problems described above cannot be solved.

### SUMMARY OF THE INVENTION

According to one aspect of the present invention, a retrieving apparatus includes a first storing unit that stores a content; a second storing unit that stores a word dictionary in which a plurality of words are registered and each of the words representing a formal name and an abbreviated name of the formal name is registered in association with a family attribute indicating a family relation among the words; a receiving unit that receives an input of a keyword as a retrieval object; a word expanding unit that reads out a word coinciding with the keyword and a word familiar with the word from the word dictionary; and a retrieving unit that retrieves a content related to any one of the words read out by the word expanding unit, from the first storing unit.

According to another aspect of the present invention, a retrieving method includes receiving an input of a keyword as a retrieval object; reading out a word coinciding with the keyword and a word familiar with the word from a word dictionary, the word dictionary registering a plurality of words and each of the words representing a formal name and an abbreviated name of the formal name in association with a family attribute indicating a family relation among the words; and retrieving a content related to any one of the words read out in the reading out.

A computer program product according to still another aspect of the present invention causes a computer to perform the method according to the present invention.

### BRIEF DESCRIPTION OF THE DRAWINGS

FIG. 1 is a diagram illustrating a hardware configuration of a retrieving apparatus;

FIG. 2 is a diagram illustrating the functional structure of a retrieving apparatus according to a first embodiment of the present invention;

FIG. 3 is a diagram illustrating an example of a program list stored in a content-information storing unit shown in FIG. 2;

FIG. 4 is a diagram illustrating an example of additional information stored in a content-material storing unit shown in FIG. 2;

FIG. 5 is a diagram illustrating an example of a word dictionary shown in FIG. 3;

FIG. 6 is a diagram illustrating another example of a word dictionary shown in FIG. 3;

FIG. 7 is a flowchart of a procedure of content retrieval processing according to the first embodiment;

FIG. 8A is a diagram illustrating an example of a screen for inputting a keyword;

FIG. 8B is a diagram illustrating an example of the screen for inputting a keyword;

FIG. 9 is a flowchart of a procedure of word expansion processing shown in FIG. 7;

FIG. 10 is a diagram illustrating an example of a screen on which a retrieval result is displayed;

FIG. 11 is a diagram illustrating the functional structure of a retrieving apparatus according to a second embodiment of the present invention;

FIG. 12 is a diagram illustrating an example of a word dictionary shown in FIG. 11;

FIG. 13 is a diagram illustrating another example of the word dictionary shown in FIG. 3;

FIG. 14 is a flowchart of a procedure of content retrieval processing according to the second embodiment;

FIG. 15 is a flowchart of a procedure of word expansion processing shown in FIG. 14;

FIG. 16 is a diagram illustrating the functional structure of a retrieving apparatus according to a third embodiment of the present invention;

FIG. 17 is a diagram illustrating an example of a word dictionary master shown in FIG. 16;

FIG. 18 is a diagram illustrating an example of a word dictionary shown in FIG. 16;

FIG. 19 is a diagram illustrating an example of the word dictionary after update;

FIG. 20 is a diagram illustrating the functional structure of a retrieving apparatus according to a fourth embodiment of the present invention;

FIG. 21 is a diagram illustrating an example of a connection destination table shown in FIG. 20;

FIG. 22A is a diagram illustrating an example of a retrieval result obtained by a Web server shown in FIG. 20;

FIG. 22B is a diagram illustrating an example of a retrieval result obtained by the Web server shown in FIG. 20;

FIG. 22C is a diagram illustrating an example of a retrieval result obtained by the Web server shown in FIG. 20;

FIG. 23 is a diagram illustrating an example of a family analysis rule shown in FIG. 20; and

FIG. 24 is a diagram illustrating another example of a word dictionary shown in FIG. 20.

### DETAILED DESCRIPTION OF THE INVENTION

Exemplary embodiments of the present invention are explained in detail below with reference to the accompanying drawings.

In the embodiments explained below, the present invention is applied to a retrieving apparatus mounted on a TV terminal, an AV-PC, and the like. However, objects to which the present invention is applied are not limited to this form.

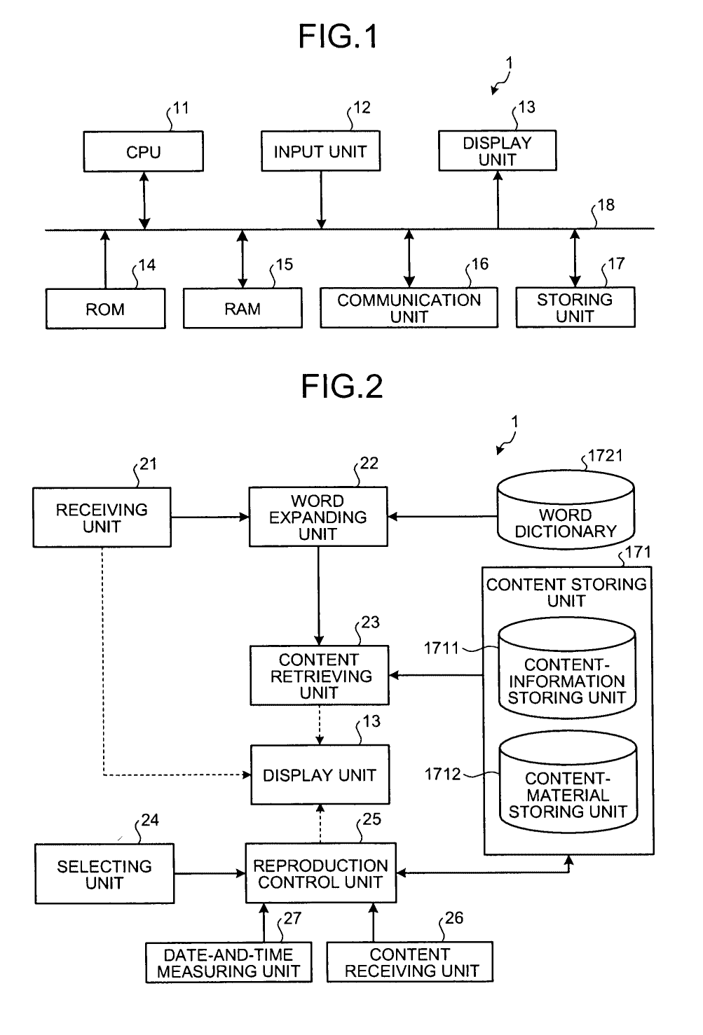

A retrieving apparatus 1 according to a first embodiment of the present invention is explained referring to FIG. 1. FIG. 1 is a block diagram illustrating a hardware configuration of the retrieving apparatus 1. As shown in FIG. 1, the retrieving apparatus 1 includes a central processing unit (CPU) 11, an input unit 12, a display unit 13, a read only memory (ROM) 14, a random access memory (RAM)) 15, a communication unit 16, and a storing unit 17, which are connected by a bus 18. Retrieving apparatuses 2 to 4 described later have hardware configurations same as the hardware configuration of the retrieving apparatus 1.

The CPU 11 executes, using a predetermined area of the RAM 15 as a work area, various kinds of processing in cooperation with various control programs stored in the ROM 14 or the storing unit 17 in advance and collectively controls operations of the respective units of the retrieving apparatus 1.

The CPU 11 realizes a plurality of functional units having predetermined functions in cooperation with predetermined programs stored in the ROM 14 or the storing unit 17 in advance. Details of the respective functional units are described later.

The input unit 12 is a remote controller, a keyboard, a microphone for speech input, or the like. The input unit 12 receives content input by a user as an indication signal and outputs the indication signal to the CPU 11.

The display unit 13 includes a display device such as a liquid crystal display (LCD). The display unit 13 displays various kinds of information based on a display signal from the CPU 11.

The ROM 14 stores programs, various kinds of setting information, and the like related to the control by the retrieving apparatus 1 so as not to be rewritable.

The RAM 15 is a volatile storage device such as a synchronous dynamic random access memory (SDRAM). The RAM 15 functions as a work area of the CPU 11 and plays a role of a butter that temporarily stores various kinds of information.

The communication unit 16 is an interface that communicates with an external apparatus through a not-shown network. The communication unit 16 outputs received various kinds of information to the CPU 11 and transmits various kinds of information output from the CPU 11 to the external apparatus. The communication unit 16 also has a function of a receiving apparatus that receives broadcast of a program from a not-shown broadcasting station.

The storing unit 17 includes a magnetically or optically recordable storage medium. The storing unit 17 stores programs, various kinds of setting information, and the like related to the control by the retrieving apparatus 1 so as to be rewritable. The storing unit 17 stores a content storing unit 171, a word dictionary 1721, and the like described later in a storage area thereof in advance.

Referring to FIG. 2, the respective functional units of the retrieving apparatus 1 realized by cooperation of the CPU 11 and the programs stored in the ROM 14 or the storing unit 17 are explained. FIG. 2 is a block diagram illustrating the functional structure of the retrieving apparatus 1 according to the first embodiment.

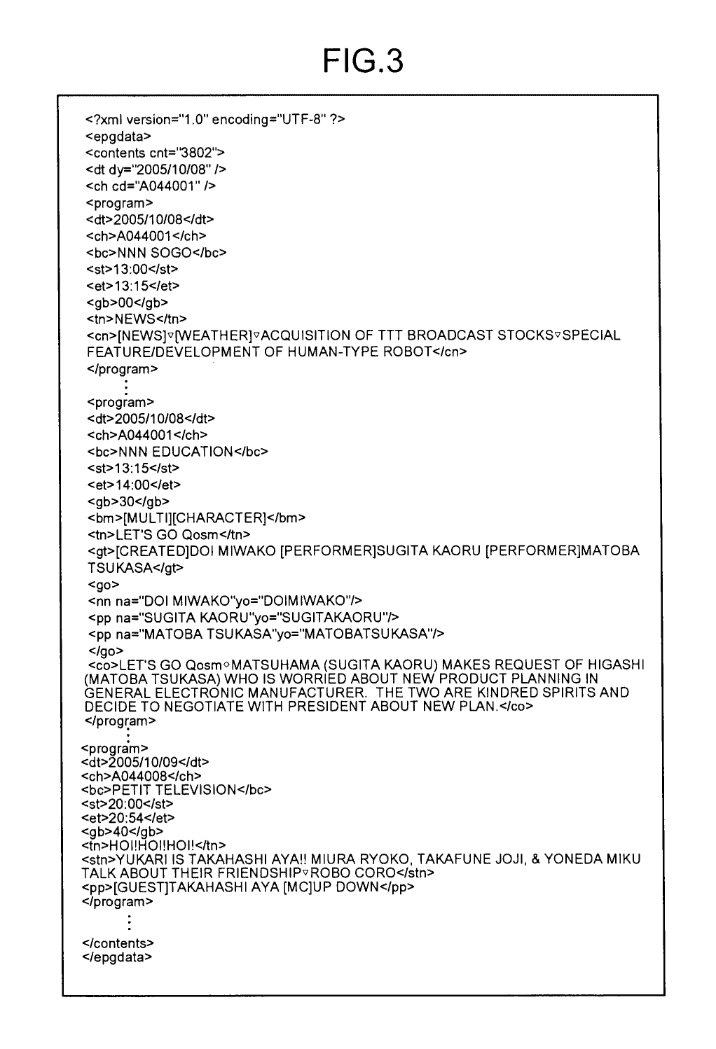

As shown in FIG. 3, the retrieving apparatus 1 includes a receiving unit 21, a speech recognizing unit 22, a speech-recognition-dictionary creating unit 23, a word expanding unit 24, a retrieval-word selecting unit 25, a content retrieving unit 26, a content selecting unit 27, a reproduction control unit 28, a content receiving unit 29, and a date-and-time measuring unit 30. The storing unit 17 stores the content storing unit 171 and the word dictionary 1721.

Various kinds of information stored in the storing unit 17 is explained. The content storing unit 171 is a storage area in which contents retrievable by the retrieving apparatus 1 are stored. The content storing unit 171 includes a content-information storing unit 1711 that stores a program list of a television and the like and a content-material storing unit 1712 that stores recorded content materials such as moving images, photographs, and music.

The program list stored in the content-information storing unit 1711 is electronic program guide data called EPG. The program list are described in an eXtensible Markup Language (XML) format as shown in FIG. 3.

FIG. 3 is a diagram illustrating an example of the electronic program guide data stored in the content-information storing unit 1711. In the figure, a tag “<?xml version=“1.0” encoding=“UTF-8”?>” indicates that the electronic program guide data is described in the XML format. The following tags from “<epgdata>” to “</epgdata>” at the end of a sentence indicate a text of the electronic program guide data.

A tag “<contents cnt=“3802”>” indicates an ID of acquired electronic program guide data. A tag “<dt dy=“2005/10/08”/> indicates that the electronic program guide data is delivered on Oct. 8, 2005. A tag “<ch cd=“A044001”/>” indicates a channel code and indicates that the channel code is A04401.

A tag “<program>” indicates that program data concerning a TV program follows. The end of the program data is a tag “</program>”. The tags from “<program>” to “</program>” represent one program (content). Programs between the tags “<program>” and “</program>” in the same format follow the program data. In this embodiment, information concerning the respective programs described in the electronic program guide data is independent content (content material) and treated in the same manner as the content material (moving image data and music data) stored in the content-material storing unit 1712.

In a first program, a tag “<dt>2005/10/08</dt>” indicates a broadcast date when this program is broadcasted. A tag “<ch>A044001<ch>” indicates a channel code and a tag “<bc>NNN Sogo</bc>” indicates a channel name. A tag “<st>13:00</st>” indicates a program start time and a tag “<et>13:15</et>” indicates a program end time.

A tag “<gb>00</gb>” indicates a genre of a program. A tag “<tn>news</tn>” indicates a program title. A tag “<cn> . . . </cn>” indicates content of the program. In other words, in the electronic program guide data, information concerning content (a program) that can be reproduced at predetermined date and time is stored.

In this embodiment, “00” of “<gb>00</gb>” indicates a news program. In the next program, “30” of “<gb>30</gb>” indicates a drama as a genre of the program.

A tag “<bm>[multi][character]</bm>” indicates a broadcast format and indicates a sound multiplex and teletex broadcast. A tag “<gt>[author]Doi Miwako[performer]Sugita Kaoru[performer]Matoba Tsukasa</gt>” briefly indicates names of people involved in production of this program. “[author]” indicates an author of this drama and “[performer]” indicates a performer.

Between tags “<go>” and “</go>”, names of people involved in production of this program are entered. A tag “<nn . . . />” indicates an author of this program (drama). A name of the author (e.g., Doi Miwako) is entered in “na=”. A tag “<pp . . . />” indicates a performer of this program. A person's name of the performer (e.g., Sugita Kaoru) is entered in “na=”. In each of the tags, a character string (e.g., sugitakaoru) indicated by “yo=” indicates “reading” of the person's name. A tag “<co> . . . </co>” indicates an outline of this program.

In the next program, “40” of “<gb>40</gb>” indicates a music program as a genre of a program. In this program, “<stn> . . . </stn>” indicates a subtitle of this program. A tag “<pp> . . . </pp>” briefly indicates a performer of this program. “[guest]” indicates a guest of this music program and “[mc]” indicates an emcee of this music program.

As described above, in the electronic program guide data, there are various programs in which readings are given to persons' names. In general, readings are often given to persons' names when a program genre is a drama. In some case, persons' names are written while being delimited by tags for each of the persons' names. However, in general, persons' names are often written in a form of a list in a program outline, a subtitle, and the like. It is assumed that the electronic program guide data is received from an external apparatus at every predetermined time according to the control by a content receiving unit 26 described later and is updated to new electronic program guide data including broadcast contents for a predetermined period (e.g., two weeks).

On the other hand, in the content-material storing unit 1712, content materials that can be always reproduced such as recorded moving image data and music data are stored as contents. A part or all of the electronic program guide data (EPG) shown in FIG. 3 are stored as additional information in association with contents recorded by receiving broadcasts.

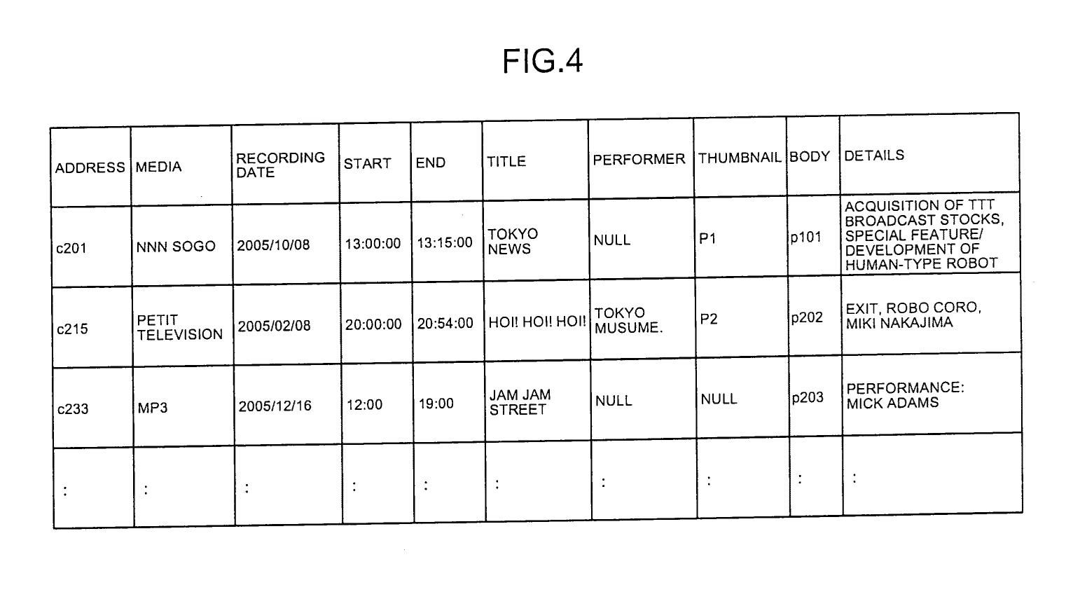

FIG. 4 is a diagram illustrating an example of additional information stored in association with the respective contents of the content-material storing unit 1712. As shown in FIG. 4, the additional information includes a media type (media) representing a broadcasting station that broadcasts content (program data), a file format, or the like, recording date and time (recording date, start time, and end time), a program title (title), a program performer of the content (performer), an address of a thumbnail image (thumbnail) representing a screen of the content, address information (body) in which a content body is present, and detailed information (details) concerning content such as program content. The additional information is associated with content corresponding thereto by the address stored in “thumbnail” or “body”. “Address” indicates an address each of the kinds of additional information (a storage address) and is automatically given when each of the kinds of additional information are registered.

In FIG. 4, a first row (address: c201) is additional information concerning content, a program genre of which is a news program. An item of the performer is “NULL (not applicable)” because there is no information corresponding to the performer.

A second row (address: c215) is additional information concerning content, a program genre of which is a music program. As explained in the example of the electronic program guide data shown in FIG. 4, an identifier “[performer]” is not given to performers in the case of a music program and the performers are listed in the subtitle or the like. Therefore, when processing higher in level than tag analysis for extracting a person's name is not performed, only the persons' names indicated by the “<pp>” tag are stored as performers.

A third row (address: c233) is additional information concerning content extracted from a music medium such as a compact disk (CD). The additional information is “NULL (not applicable)” because a performer and a thumbnail are not present.

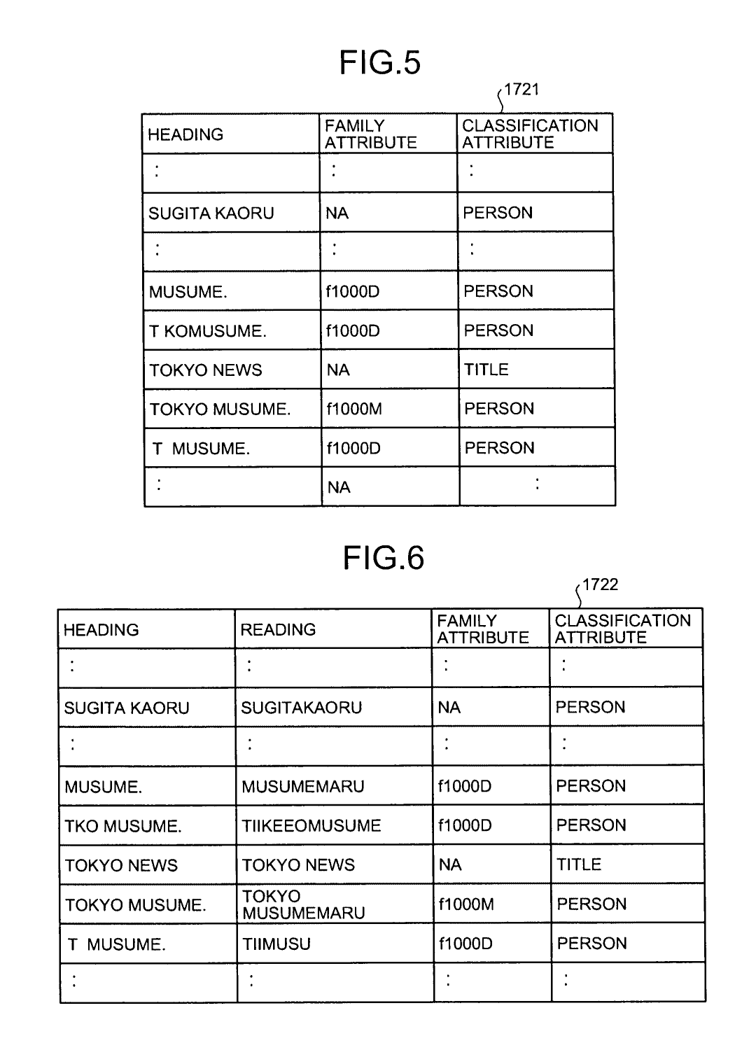

The storing unit 17 stores a word dictionary 1721 in a storage area thereof. FIG. 5 is a diagram illustrating an example of the word dictionary 1721 stored in the storing unit 17. As shown in FIG. 5, in the word dictionary 1721, for each of headings of respective words, a family attribute and a classification attribute are registered in association with each other.

The family attribute is information representing a parent-child relation among the words. Specifically, the family attribute represents a relation between a formal name and an alias such as an abbreviated word or a nickname of the name. For example, in a heading “Tokyo Musume.”, the family attribute is “f1000M”. “f1000” of “f1000M” is identification information (family information) for identifying a group of words having the same word (a formal name) as a parent. Common family information is given to the words in the same group. “M” indicates a word as the origin of a word (Mother) of this group, i.e., the formal name. It is assumed that pieces of family information different from each other are given to respective words, which are formal names.

“D” is given to words other than the formal name instead of “M”. For example, in a heading “T Musu.”, the family attribute is “f1000D”. This indicates that “T Musu.” is a child (Daughter) of the family “f1000M”, i.e., an alias of “Tokyo Musume.”. The family attribute is not given to words not having aliases. “NA” meaning non-application of the family attribute is given to the words.

In the classification attribute, field names of objects represented by the respective words are registered. The respective words are classified by these field names. In an example shown in FIG. 5, “person” and “title” are field names. However, the field names are not limited to these and other field names such as “entertainer” and “others” can be used. In the example shown in FIG. 5, for each of headings of respective words, a family attribute among the words and a classification attribute of each of the words are associated with each other. However, items registered in the word dictionary 1721 are not limited to these. For example, in addition to a relation between the family attribute and the classification attribute for each of the words, “reading” of the respective words can be registered.

FIG. 6 is a diagram illustrating an example of a word dictionary 1722 in which an item of “reading” is added to the word dictionary 1721. As shown in FIG. 6, in the word dictionary 1722, for each of headings of respective words, “reading”, “family attribute”, and “classification attribute” of the word are registered in association with one another. The structure of the word dictionary 1722 is the same as that of the word dictionary 1721 shown in FIG. 5 except that “reading” of the respective words is added in a second row. “Reading” associated with the respective words can be used for speech recognition when the user inputs a word by speech or when the user reads out the respective words using a speech synthesis technology.

The respective functional units of the retrieving apparatus 1 are explained. The receiving unit 21 is a functional unit that receives various indication signals related to retrieval of content input via the input unit 12. Specifically, the receiving unit 21 receives an indication signal indicating the start of retrieval via the input unit 12, displays a screen for urging input of a retrieval object word (keyword) on the display unit 13, and receives a keyword input based on the screen. When a keyword is input as speech information via a microphone or the like, the receiving unit 21 converts the input speech information into a character string using a publicly-known speech recognition technology and sets a result of the conversion as a retrieval object keyword.

The word expanding unit 22 retrieves, based on the keyword received by the receiving unit 21, a word that is in a family relation with the keyword from the words registered in the word dictionary 1721.

Specifically, the word expanding unit 22 reads out a word corresponding to the keyword received by the receiving unit 21 and reads out, based on a family attribute of the retrieved word, a word (a family word) tied to the word from the word dictionary 1721 to expand the retrieval object word (keyword).

The content retrieving unit 23 retrieves, based on the keyword and the expanded family words, content including the keyword or any one of character strings representing the family words in electronic program guide data or additional information thereof from the content-information storing unit 1711 and the content-material storing unit 1712 of the content storing unit 171.

Specifically, the content retrieving unit 23 judges whether a character string coinciding with the input keyword or any one of the character strings representing the family words is present in information such as program titles included in contents described in a program guide of the content-information storing unit 1711 and information such as program titles included in additional information of the contents stored in the content-material storing unit 1712. The content retrieving unit 23 causes the display unit 13 to display thumbnail images, information related thereto, and the like concerning the contents including the character string coinciding with the keyword or any one of the character strings representing the family words.

The selecting unit 24 is a functional unit that receives, via the input unit 12, an indication signal for selecting specific content from the contents displayed on the display unit 13 according to the control by the content retrieving unit 23. When the indication signal is input as speech information via a speech input device such as a microphone, the selecting unit 24 converts the input speech information according to the publicly-known speech recognition technology and sets a result of the conversion as an indication signal.

The reproduction control unit 25 causes the display unit 13 to display various GUIs for supporting operation of the retrieving apparatus 1. The reproduction control unit 25 controls reproduction of the content selected via the selecting unit 24.

Specifically, the reproduction control unit 25 judges in which of the content-information storing unit 1711 and the content-material storing unit 1712 the selected content is stored. When the selected content is stored in the content-material storing unit 1712, the reproduction control unit 25 reproduces the content and causes the display unit 13 to display the content.

When it is judge that the selected content is stored in the content-information storing unit 1711, i.e., when it is judged that the selected content is a program described in the electronic program guide data, the reproduction control unit 25 refers to a broadcast date, start time, and end time of the program and compares the broadcast date, the start time, and the end time with present date time measured by the date-and-time measuring unit 27. It is assumed that the broadcast date, the start time, and the end time of the program are acquired from character string portions between tags “<dt>” and “</dt>”, tags “<st>” and “</st>”, and tags “<et>” and “</et>” among the electronic program guide data shown in FIG. 3.

When it is judged that the broadcast date, the start time, and the end time of the selected program overlap the present date and time in time series, the reproduction control unit 25 judges that the program is a program presently being broadcasted. The reproduction control unit 25 causes the content receiving unit 26 to receive a broadcast of the program and causes the display unit 13 to display the program. When it is judged that the broadcast date and the start time of the selected program are further in the past than the present date and time, reproduction of the program is impossible. Therefore, the reproduction control unit 25 causes the display unit 13 to display information indicating to that effect.

When it is judged that the broadcast date and the start time of the selected program is further in the future than the present date and time, i.e., it is judged that the selected program is a program scheduled to be broadcasted, the reproduction control unit 25 schedules recording of the program. When the program recording is scheduled in this way, the reproduction control unit 25 causes the content receiving unit 26 to receive the program at the broadcast date and time of the program and starts recording of the program. Recording means storing actual data (video data and sound data) of the program and electronic program guide data (additional information) of the program in the content-material storing unit 1712 in association with each other.

The content receiving unit 26 receives, based on the electronic program guide data of the content (the program) indicated by the reproduction control unit 25, the broadcast of the program through the communication unit 16.

The date-and-time measuring unit 27 measures present date and time based on a clock signal generated from a not-shown clock generator or the like.

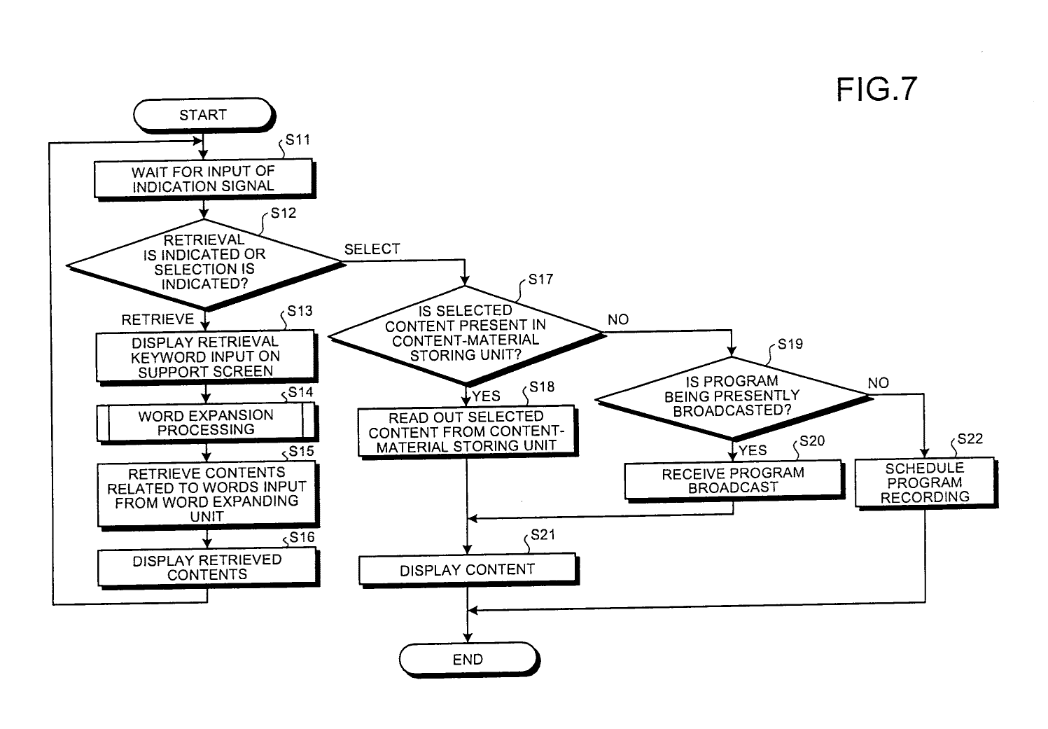

FIG. 7 is a flowchart of a procedure of content retrieval processing executed by the respective functional units of the retrieving apparatus 1.

First, the receiving unit 21 is on standby until an indication signal is input via the input unit 12 (step S11). When it is judged that an indication signal for starting retrieval is input via the input unit 12 (“retrieve” at step S12), the receiving unit 21 causes the display unit 13 to display a screen (a GUI) for supporting input of a keyword (step S13).

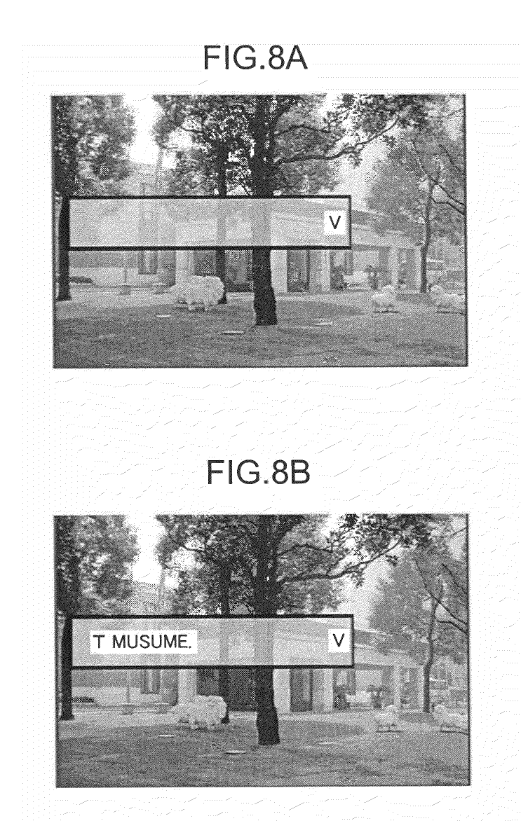

FIG. 8A is a diagram illustrating an example of the GUI for supporting input of a keyword displayed on the display unit 13. The user can input a keyword (e.g., T Musu.), which the user desires to retrieve, based on the GUI as shown in FIG. 8B. A keyword input in the GUI is received by the receiving unit 21.

Referring back to FIG. 7, when a retrieval object keyword is input via the input unit 12 and received by the receiving unit 21, the word expanding unit 22 executes word expansion processing based on the keyword (step S14).

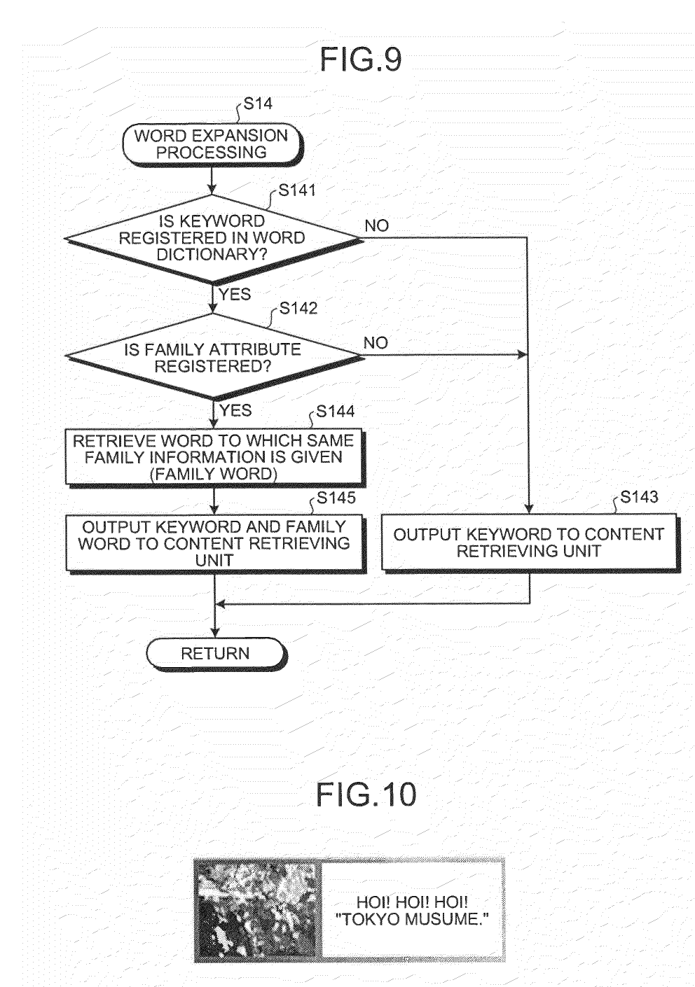

FIG. 9 is a flowchart of a procedure of the word expansion processing at step S14. First, the word expanding unit 22 judges, referring to the respective words registered in the word dictionary 1721, whether a word coinciding with the input keyword is registered in the word dictionary 1721 (step S141). When it is judged that a word coinciding with the keyword is not registered in the word dictionary 1721 (“No” at step S141), the word expanding unit 22 outputs the received keyword to the content retrieving unit 23 (step S143) and shifts to the processing at step S15.

On the other hand, when it is judged at step S141 that a word coinciding with the keyword is registered in the word dictionary 1721 (“Yes” at step S141), the word expanding unit 22 judges whether a family attribute is registered in association with the word coinciding with the keyword (step S142). When it is judged that a family attribute is not registered in the retrieved word (“No” at step S142), the word expanding unit 22 outputs the received keyword to the content retrieving unit 23 (step S143) and shifts to the processing at step S15.

When it is judged at step S142 that a family attribute is registered in the retrieved word (“Yes” at step S142), the word expanding unit 22 retrieves, from the word dictionary 1721, based on the family attribute, a word tied to the word (the keyword), i.e., a word (family word) to which the same family information is given and reads out a family word corresponding to the family attribute (step S144).

The word expanding unit 22 outputs the family word read out at step S144 to the content retrieving unit 23 together with the keyword (step S145) and shifts to the processing at step S15.

An operation of the word expansion processing shown in FIG. 9 is explained referring to the word dictionary 1721 shown in FIG. 5 as an example. First, when “T Musu.” is input from the input unit 12 as a keyword, at step S141, the word expanding unit 22 retrieves a word coinciding with “T Musu.” from the words registered in the word dictionary 1721. Because “T Musu.” is registered in the word dictionary 1721, the word expanding unit 22 proceeds to judgment on whether there is a family attribute (step S142).

A family attribute of “T Musu.” registered in the word dictionary 1721 is “f1000D”. In other words, family information “f1000” representing presence of another word tied to “T Musu.” is present. Therefore, the word expanding unit 22 executes processing at step S144.

At step S144, the word expanding unit 22 retrieves, from the word dictionary 1721, words to which the same family information is given. Because the family information is “f1000”, words to which “f1000” is given, i.e., “Tokyo Musume.” (f1000M), “Musume.” (f1000D), and “TKO Musume.” (f1000D) are read out as family words of “T Musu.”. Therefore, at the following step S145, the word expanding unit 22 outputs the family words “Tokyo Musume.”, “Musume.”, and “TKO Musume.” to the content retrieving unit 23 together with the keyword “T Musu.”.

Referring back to FIG. 7, in the following step S15, the content retrieving unit 23 retrieves, referring to the program guide stored in the content-information storing unit 1711 and additional information of the contents stored in the content-material storing unit 1712, contents including a character string coinciding with the keyword input from the word expanding unit 22 or each of the family words (step S15). For example, when the keyword is “T Musu.” and the family words tied to the keyword are “Tokyo Musume.”, “Musume.”, and “TKO Musume.”, the content retrieving unit 23 retrieves contents including a character string of any one of “T Musu.”, “Tokyo Musume.”, “Musume.”, and “TKO Musume.”.

The content retrieving unit 23 causes the display unit 13 to display the contents retrieved at step S15 in an identifiable form (step S16) and returns to the processing at step S11. When no relevant content is present in the retrieval processing at step S15, information notifying to that effect is displayed on the display unit 13.

FIG. 10 is a diagram illustrating an example of a screen displayed on the display unit 13 according to the processing at step S16. A retrieval result concerning “Tokyo Musume.” is shown. Because “Tokyo Musume.” is present in performer of an address c215 in FIG. 3, related information such as a thumbnail of this content is displayed on the display unit 13.

Referring back to FIG. 7, at step S11, an indication signal for selecting a processing object content from a list of the contents displayed at step S16 is received by the selecting unit 24 (“select” at step S12). The reproduction control unit 25 judges whether the selected content is stored in the content-material storing unit 1712 (step S17).

When it is judged at step S17 that the selected content is stored in the content-material storing unit 1712 (“Yes” at step S17), the reproduction control unit 25 reads out relevant content from the content-material storing unit 1712 (step S18), causes the display unit 13 to display the content (step S21), and finishes this processing.

When it is judged at step S17 that the selected content is stored in the content-information storing unit 1711, i.e., it is judged that the selected content is a program described in electronic program guide data (“No” at step S17), the reproduction control unit 25 compares a broadcast date, start time, and end time of the program and present date and time (step S19).

When it is judged that the broadcast date, the start time, and the end time of the selected program overlap the present date and time in time series, i.e., it is judged that the program is a program being presently broadcasted (“Yes” at step S19), the reproduction control unit 25 causes the content receiving unit 26 to receive a broadcast of the program (step S20), causes the display unit 13 to display the program (step S21), and finishes this processing.

When it is judged that the broadcast date and the start time of the selected program are further in the future than the present date and time, i.e., when it is judged that the selected program is a program scheduled to be broadcasted (“No” at step S19), the reproduction control unit 25 schedules recording of the program (step S22) and finishes this processing.

As described above, according to the first embodiment, even when one keyword is input as a retrieval object by the user, a word tied to the keyword can be included in the retrieval object based on family attributes of the words registered in the word dictionary. Therefore, it is possible to efficiently retrieve contents related to a name represented by the keyword and an alias of the name and improve convenience for the user.

In this embodiment, signs “D” and “M” are included in a family attribute to clearly indicate a word as the origin of a word and a word as an alias of the word. However, the present invention is not limited to this. “D” and “M” do not have to be included in the family attribute.

In this embodiment, contents related to a character string among character strings representing a keyword or respective family words are retrieved from the content-information storing unit 1711 and the content-material storing unit 1712. However, the present invention is not limited to this. For example, relevant content can be retrieved from one of the content-information storing unit 1711 and the content-material storing unit 1712.

In the example explained in this embodiment, the word dictionary 1721 is used. However, the same control is performed when the word dictionary 1722 is used.

Next, a retrieving apparatus according to a second embodiment of the present invention is explained. Components same as those in the first embodiment are denoted by the same reference numerals and signs and explanation of the components is omitted.

In the first embodiment, contents stored in the content-information storing unit 1711 are electronic program guide (EPG) data. Therefore, the contents are updated as time elapses. Contents stored in the content-material storing unit 1712 are contents recorded by the user. Therefore, new content is stored every time recording is performed.

Because the contents change as time elapses as described above, words registered in the word dictionary 1721 also need to follow the change in the content-information storing unit 1711 and the content-material storing unit 1712. However, in the first embodiment, because the word dictionary 1721 (or the word dictionary 1722) is a fixed dictionary stored in advance, it is likely that the word dictionary 1721 (or the word dictionary 1722) cannot follow such a change and store new words.

A retrieving apparatus 2 according to the second embodiment can follow the change with time of contents described above.

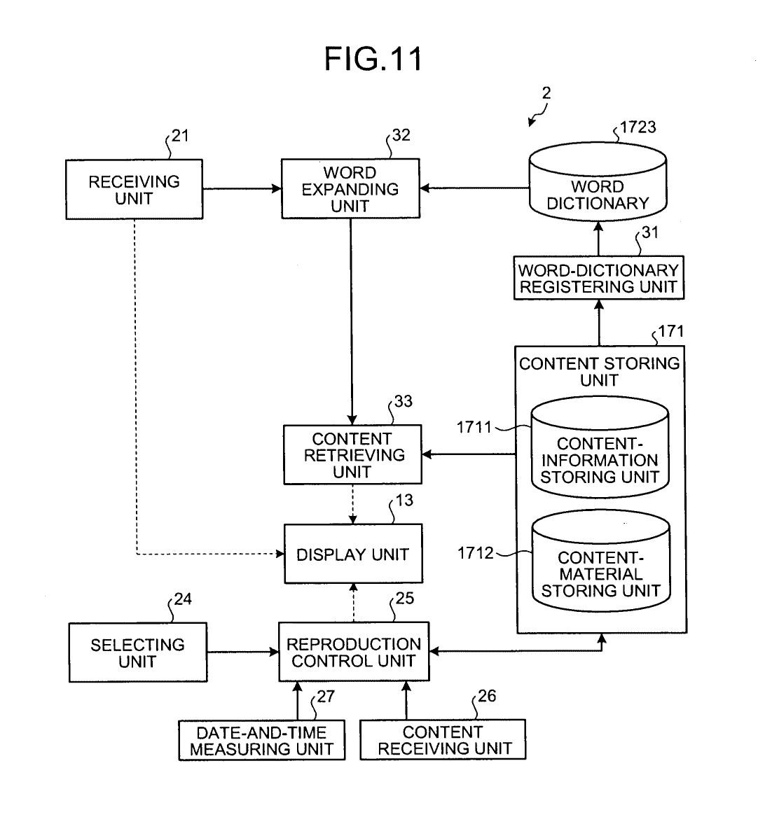

Referring to FIG. 11, respective functional units of the retrieving apparatus 2 realized by cooperation of the CPU 11 and the programs stored in the ROM 14 or the storing unit 17 are explained. FIG. 11 is a block diagram illustrating the functional structure of the retrieving apparatus 2 according to the second embodiment.

As shown in FIG. 11, the retrieving apparatus 2 includes a word-dictionary registering unit 31, a word expanding unit 32, and a content retrieving unit 33 in addition to the receiving unit 21, the selecting unit 24, the reproduction control unit 25, the content receiving unit 26, and the date-and-time measuring unit 27 described above. The storing unit 17 stores a word dictionary 1723 instead of the word dictionary 1721.

The word-dictionary registering unit 31 extracts a word by applying morphological analysis to character strings included the contents (see FIGS. 3 and 4) stored in the content-information storing unit 1711 and the content-material storing unit 1712 and registers the extracted word in the word dictionary 1723.

The morphological analysis is a technology for dividing a character string into morphemes (minimum units having meanings in a language). In the morphological analysis, graph structure called lattice in which morpheme candidates are listed is formed based on a dictionary that includes a word list having information such as “part of speech”, information defining conjugated forms of words of the word list, and information concerning readings of the words (all of which are not shown in the figure). A word most likely to be a candidate is extracted from the graph structure according to rules or statistical processing. It is possible to use a publicly-known technology for the morphological analysis.

In registering the extracted word in the word dictionary 1723, the word-dictionary registering unit 31 registers, in association with the extracted word, a presence attribute indicating in which of the content-information storing unit 1711 and the content-material storing unit 1712 the extracted word is stored.

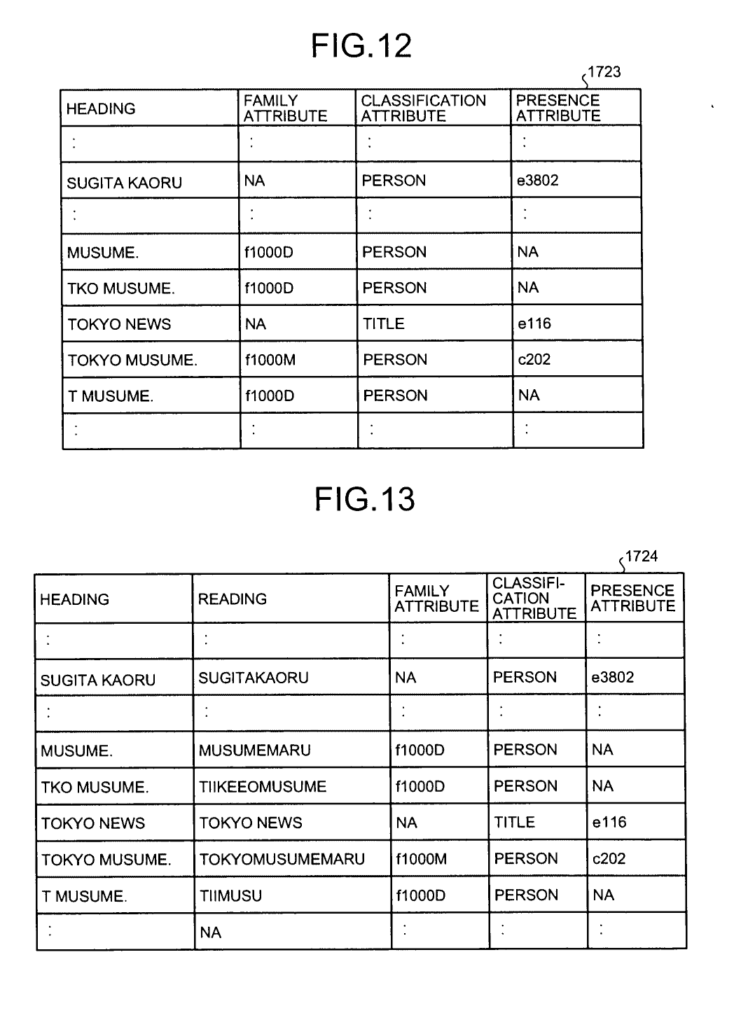

FIG. 12 is a diagram illustrating an example of the word dictionary 1723 stored in the storing unit 17. As shown in FIG. 12, for each of headings of respective words, a family attribute, a classification attribute, and a presence attribute are registered in association with one another.

The word dictionary 1723 shown in FIG. 12 is different from the word dictionary 1721 shown in FIG. 4 only in the presence attribute on the last row. The presence attribute indicates storage locations of the respective words. Specifically, the presence attribute indicates whether the word indicated by the heading is present in the content storing unit 171 and, when the word is present, in which of the content-information storing unit 1711 and the content-material storing unit 1712 the word is present.

For example, in the case of “Tokyo Musume.”, “c202” is registered as the presence attribute. “c” of “c202” indicates that the word is stored in the content-material storing unit 1712. In the case of “Sugita Kaoru”, “e3802” is registered as the presence attribute. “e” of “e3802” indicates that the word is stored in the content-information storing unit 1711. A character string (e.g., 3802) following “c” or “e” means an address (a storage address) of a header of content in which the word is present.

On the other hand, in the case of “T Musu.”, the presence attribute is “NA”. This means that the word “T Musu.” is not present in both the content-information storing unit 1711 and the content-material storing unit 1712.

Like the word dictionary 1722 shown in FIG. 5, a word dictionary 1724 in which readings of the respective words registered in the word dictionary 1723 are added can be used.

FIG. 13 is a diagram illustrating an example of the word dictionary 1724. As shown in FIG. 13, in the word dictionary master 1724, for each of headings of respective words, “reading”, “family attribute”, “classification attribute”, and “presence attribute” are stored in association with one another. The structure of the word dictionary 1724 is the same as that of the word dictionary 1723 shown in FIG. 12 except that “reading” of the respective words is added on a second row.

Referring back to FIG. 11, the word expanding unit 32 retrieves words corresponding to the keyword received by the receiving unit 21 from the word dictionary 1723. The word expanding unit 32 retrieves, based on family attributes of the retrieved words, family words tied to the word from the word dictionary 1723. The word expanding unit 32 outputs, together with the retrieved words, presence attributes related to the respective words to the content retrieving unit 33.

The content retrieving unit 33 retrieves, based on the retrieved words retrieved by the word expanding unit 32 and the presence attributes, content including any one of character strings representing the respective words in electronic program guide data or additional information thereof from the content-information storing unit 1711 and the content-material storing unit 1712.

Specifically, the content retrieving unit 33 retrieves a word indicated as being stored in the content-information storing unit 1711 by the presence attribute from the content-information storing unit 1711. The content retrieving unit 33 retrieves a word indicated as being stored in the content-material storing unit 1712 by the presence attribute from the content-material storing unit 1712. A word, the presence attribute of which is “NA”, is a word not present in the content-information storing unit 1711 and the content-material storing unit 1712. Therefore, retrieval for the word is not performed.

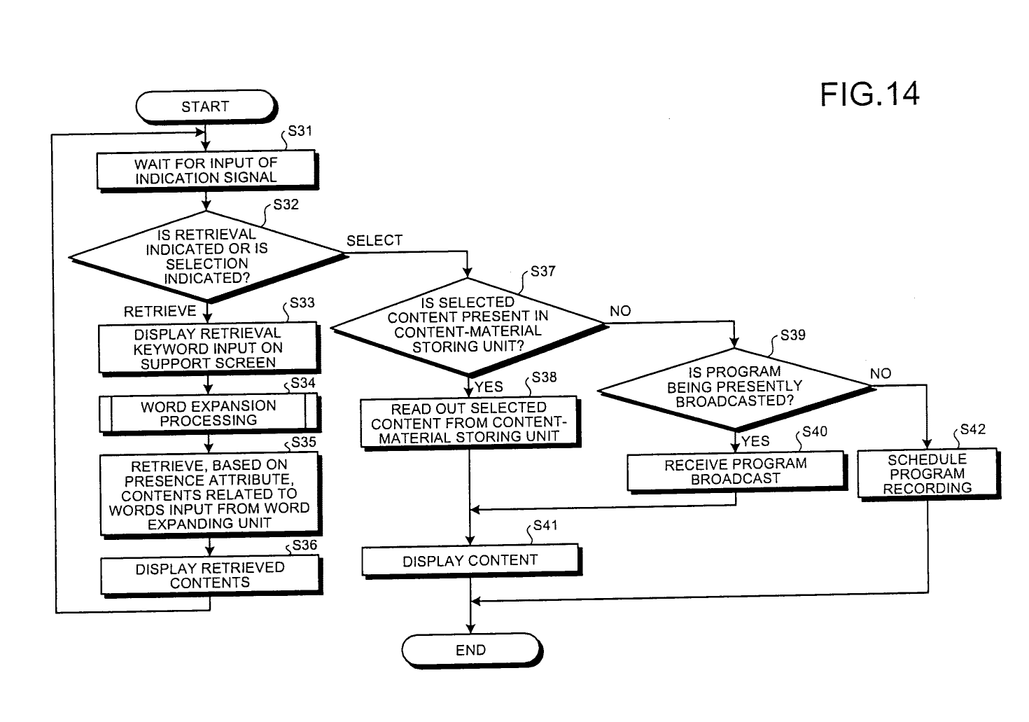

FIG. 14 is a flowchart of a procedure of content retrieval and reproduction processing executed by the respective functional units of the retrieving apparatus 2.

First, the receiving unit 21 is on standby until an indication signal is input from the input unit 12 (step S31). In this state, when it is judged that an indication signal indicating retrieval of content is received by the receiving unit 21 (“retrieve” at step S32), the receiving unit 21 causes the display unit 13 to display a GUI for urging input of a keyword (step S33).

When a retrieval object keyword is input via the input unit 12 and the keyword is received by the receiving unit 21, the word expanding unit 32 executes word expansion processing based on the keyword (step S34).

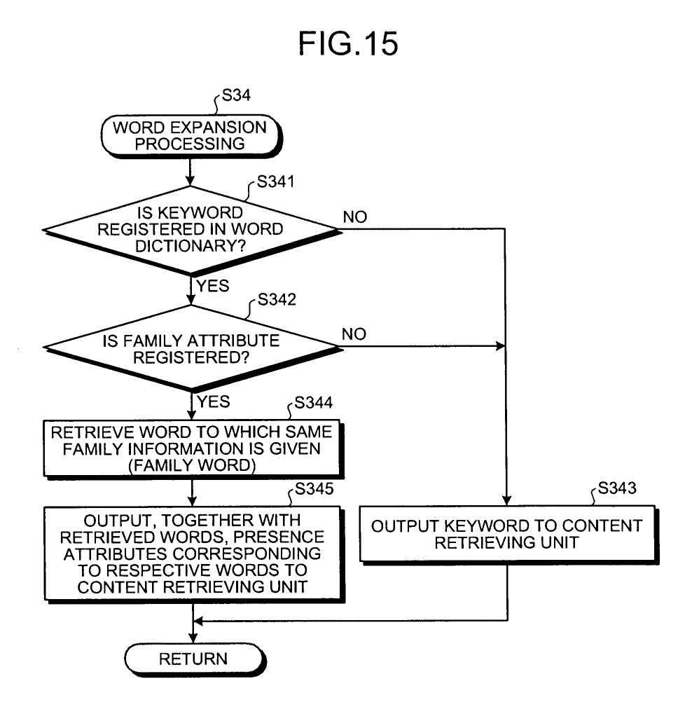

FIG. 15 is a flowchart of a procedure of the word expansion processing at step S34. First, the word expanding unit 32 judges, referring to the respective words registered in the word dictionary 1723, whether a word coinciding with the input keyword is registered in the word dictionary 1723 (step S341). When it is judged that a word coinciding with the keyword is not registered in the word dictionary 1723 (“No” at step S341), the word expanding unit 32 outputs the received keyword to the content retrieving unit 33 (step S343) and shifts to processing at step S35.

On the other hand, when it is judged at step S341 that a word coinciding with the keyword is registered in the word dictionary 1723 (“Yes” at step S341), the word expanding unit 32 judges whether a family attribute is registered in association with the coinciding word (step S342). When it is judged that a family attribute is not registered for the retrieved word (“No” at step S342), the word expanding unit 32 outputs the received keyword to the content retrieving unit 33 (step S343) and shifts to the processing at step S35.

On the other hand, when it is judged at step S342 that a family attribute is registered in the retrieved word (“Yes” at step S342), the word expanding unit 32 retrieves, from the word dictionary 1723, based on the family attribute, a word tied to the word (the keyword), i.e., words to which the same family information is given (step S344).

The word expanding unit 32 outputs presence attributes corresponding to the retrieved respective words (including the keyword) to the content retrieving unit 33 together with the words (step S345) and shifts to the processing at step S35.

An operation of the word expansion processing shown in FIG. 15 is explained referring to the word dictionary 1723 shown in FIG. 12 as an example. First, when “T Musu.” is input from the input unit 12 as a keyword, at step S341, the word expanding unit 32 retrieves a word coinciding with “T Musu.” from the words registered in the word dictionary 1723. Because “T Musu.” is registered in the word dictionary 1723, the word expanding unit 32 proceeds to judgment on whether there is a family attribute (step S342).

A family attribute of “T Musu.” registered in the word dictionary 1723 is “f1000D”. In other words, family information “f1000” representing presence of another word tied to “T Musu.” is present. Therefore, the word expanding unit 32 executes processing at step S344.

At step S344, the word expanding unit 32 retrieves, from the word dictionary 1723, words to which the same family information is given. Because the family information is “f1000”, words to which “f1000” is given, i.e., “Tokyo Musume.” (f1000M), “Musume.” (f1000D), and “TKO Musume.” (f1000D) are read out as family words of “T Musu.”.

At the following step S345, the word expanding unit 32 outputs the retrieved words and presence attributes to the content retrieving unit 33. In other words, the word expanding unit 32 outputs “(T Musu., NA)”, “(Tokyo Musume., c202)”, “(Musume., NA)”, and “(TKO Musume., NA)” to the content retrieving unit 33.

Referring back to FIG. 14, in the following step S35, the content retrieving unit 33 retrieves, referring to the program guide stored in the content-information storing unit 1711 and additional information of the contents stored in the content-material storing unit 1712, contents including character strings coinciding with the respective words input from the word expanding unit 32 based on the presence attributes (step S35).

For example, when “(T Musu., NA)”, “(Tokyo Musume., c202)”, “(Musume., NA)”, and “(TKO Musume., NA)” are input from the word expanding unit 32, the content retrieving unit 33 retrieves words, presence information of which is other than “NA”, from storage locations indicated by the presence attributes.

When only the keyword input from the word expanding unit 32 is input, i.e., when the keyword output at step S343 is input, presence information itself is not given. Therefore, the content retrieving unit 33 retrieves contents including a character string coinciding with the keyword from the content-information storing unit 1711 and the content-material storing unit 1712.

The content retrieving unit 33 causes the display unit 13 to display the contents retrieved at step S35 in an identifiable form (step S36) and returns to the processing at step S31. When relevant content is not present in the retrieval processing at step S35, information notifying to that effect is displayed on the display unit 13.

At step S31, an indication signal for selecting a processing object content from a list of the contents displayed at step S36 is received by the selecting unit 24 (“select” at step S32). The reproduction control unit 25 judges whether the selected content is stored in the content-material storing unit 1712 (step S37).

When it is judged at step S37 that the selected content is stored in the content-material storing unit 1712 (“Yes” at step S37), the reproduction control unit 25 reads out relevant content from the content-material storing unit 1712 (step S38), causes the display unit 13 to display the content (step S41), and finishes this processing.

When it is judged at step S37 that the selected content is stored in the content-information storing unit 1711, i.e., it is judged that the selected content is a program described in electronic program guide data (“No” at step S37), the reproduction control unit 25 compares a broadcast date, start time, and end time of the program and present date and time (step S39).

When it is judged that the broadcast date, the start time, and the end time of the selected program overlap the present date and time in time series, i.e., it is judged that the program is a program being presently broadcasted (“Yes” at step S39), the reproduction control unit 25 causes the content receiving unit 26 to receive a broadcast of the program (step S40), causes the display unit 13 to display the program (step S41), and finishes this processing.

On the other hand, when it is judged that the broadcast date and the start time of the selected program are further in the future than the present date and time, i.e., when it is judged that the selected program is a program scheduled to be broadcasted (“No” at step S39), the reproduction control unit 25 schedules recording of the program (step S42) and finishes this processing.

As described above, according to the second embodiment, even when one keyword is input as a retrieval object by the user, a word tied to the keyword can be included in the retrieval object based on family attributes of the words registered in the word dictionary. Therefore, it is possible to efficiently retrieve contents related to a name represented by the keyword and an alias of the name and improve convenience for the user.

According to this embodiment, presence attributes of respective words included in respective contents are registered in the word dictionary and contents are retrieved based on the presence attributes. Therefore, it is possible to more efficiently retrieve contents related to a name represented by the keyword and an alias of the name.

In this embodiment, as shown in FIGS. 12 and 13, an address of a header of content in which a word is present is included in the presence attribute. However, the present invention is not limited to this.

For example, only information indicating in which of the content-information storing unit 1711 and the content-material storing unit 1712 the word is present can be included in the presence attribute. Specifically, when the word is present in the content-information storing unit 1711, “e” can be included in the presence attribute, when the word is present in the content-material storing unit 1712, “c” can be included in the presence attribute, and, when the word is not present in both the content-information storing unit 1711 and the content-material storing unit 1712, “NA” can be included in the presence attribute.

In FIGS. 12 and 13, only one piece of presence information is associated with each of the headings. However, the present invention is not limited to this. For example, a certain word can be present in both the content-information storing unit 1711 and the content-material storing unit 1712. In such a case, two pieces of presence information can be registered.

Next, a retrieving apparatus according to a third embodiment of the present invention is explained. Components same as those in the first and second embodiments are denoted by the same reference numerals and signs and explanation of the components are omitted.

In the first and second embodiments, it is assumed that a family attribute is manually given by the user. However, names such as names of singers and titles of programs change because the names are abbreviated as abbreviated names and nicknames of the names are created as the names are spoken in more opportunities. Therefore, in the first and second embodiments, it is difficult to cope with such a change.

In the second embodiment, it is possible to subject character strings included in the content-information storing unit 1711 and the content-material storing unit 1712 to morphological analysis and extract a word with the word-dictionary registering unit 31. However, in this form, although it is possible to register the extracted word in the word dictionary 1723 (or the word dictionary 1724) and specify a location where the word is stored, it is impossible to judge whether the extracted word is in a family relation with other words.

In the second embodiment, words generally used in abbreviated forms such as “Tokyo Daigaku”, which is abbreviated as “Todai”, “United States of America”, which is abbreviated as “Bei”, “Inter Collage”, which is abbreviated as “Inkare”, and “Computer Graphics”, which is abbreviated as “CG”, can be included in the dictionary used for morphological analysis as abbreviated words to cope with the change. However, it is difficult to catch up with aliases that change following the current of the times such as “T Musu.”, “Musume.”, “TKO Musume.”, which are abbreviations of “Tokyo Musume.”.

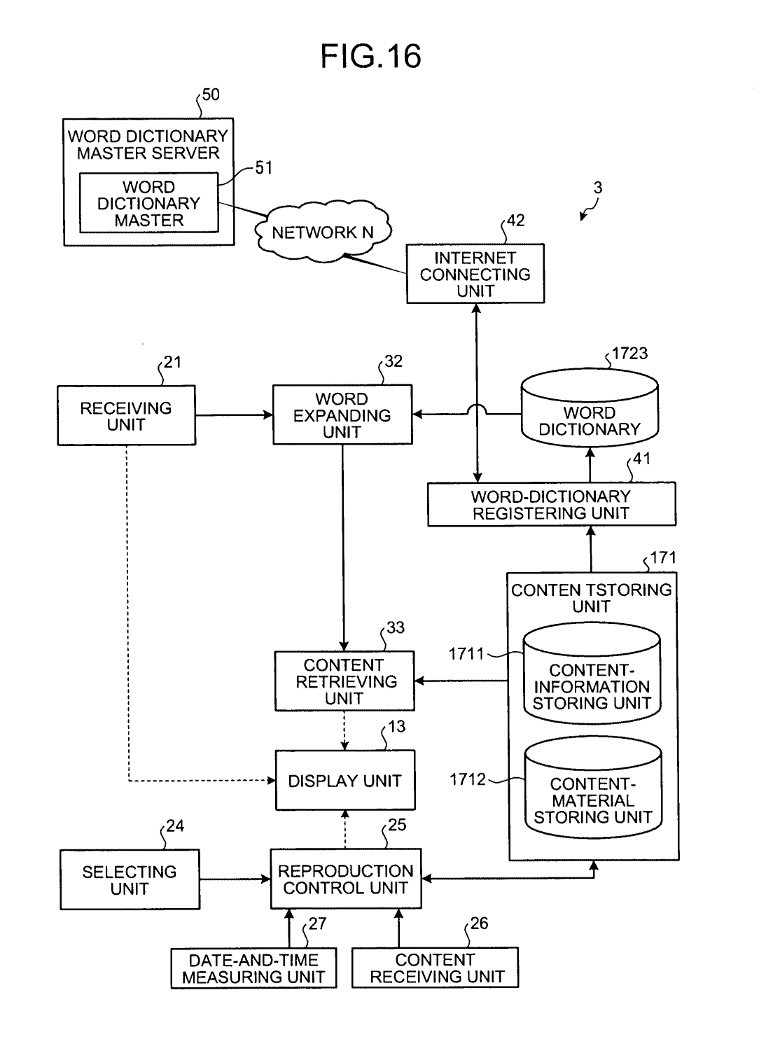

Therefore, in the third embodiment, a retrieving apparatus 3 that can solve the problems is explained. First, referring to FIG. 16, respective functional units of the retrieving apparatus 3 realized by cooperation of the CPU 11 and the programs stored in the ROM 14 or the storing unit 17 are explained. FIG. 16 is a block diagram illustrating the functional structure of the retrieving apparatus 3 according to the third embodiment.

As shown in FIG. 16, the retrieving apparatus 3 includes a word-dictionary registering unit 41 and an Internet connecting unit 42 in addition to the receiving unit 21, the selecting unit 24, the reproduction control unit 25, the content receiving unit 26, the date-and-time measuring unit 27, the word expanding unit 32, and the content retrieving unit 33 described above. The retrieving apparatus 3 and a word dictionary master server 50 are connected to be capable of communicating with each other through a network N such as the Internet.

The word dictionary master server 50 is a Web server, an ftp server, or the like capable of providing an external apparatus with information and is an information resource present on the network N. Specifically, the word dictionary master server 50 provides, in response to a request from the retrieving apparatus 3, the external apparatus (the retrieving apparatus 3) with a word dictionary master 51 stored in the word dictionary master server 50 itself. The word dictionary master 51 is a word dictionary that is a master of the word dictionary 1723 (or the word dictionary 1724). In the word dictionary 1723 (or the word dictionary 1724), a relation between respective words and aliases of the words is updated at a predetermined time interval (e.g., every few hours) manually by others or automatically by using a Backus-Naur form described later.

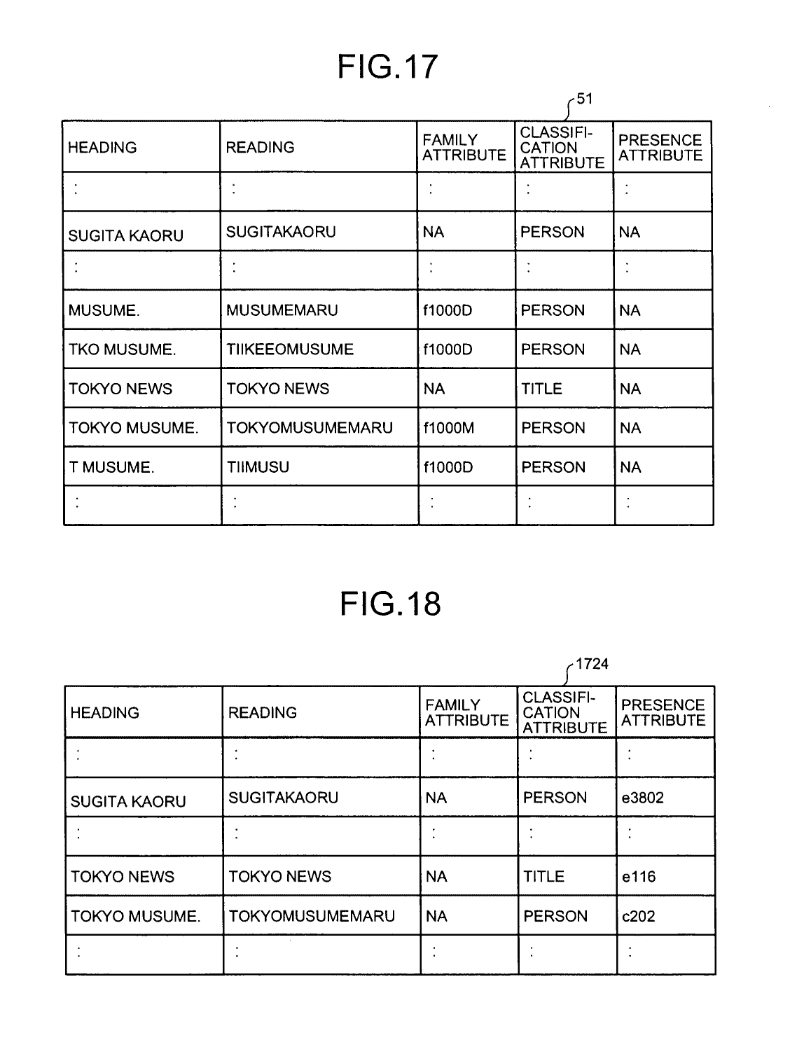

FIG. 17 is a diagram illustrating an example of the word dictionary master 51. As shown in FIG. 17, in the word dictionary master 51, for each of headings of respective words, “reading”, “family attribute”, “classification attribute”, and “presence attribute” are stored in association with one another. Explanation of the respective items is the same as the above explanation. In the example shown in FIG. 17, “presence attribute” is associated with the respective headings. However, “presence attribute” can be omitted. When “presence attribute” is associated with the headings as in the example shown in FIG. 17, it is preferable to give “NA” to “presence attribute”.

Referring back to FIG. 16, the word-dictionary registering unit 41 has functions same as those of the word-dictionary registering unit 31. The word-dictionary registering unit 41 acquires the word dictionary master 51 from the word dictionary master server 50 via the Internet connecting unit 42 and compares the word dictionary master 51 and the word dictionary 1723 to update the content of the word dictionary 1723.

Specifically, the word-dictionary registering unit 41 merges the respective items “heading”, “reading”, “family attribute”, “classification attribute”, and “presence attribute” of the word dictionary master 51 with the word dictionary 1723 to update the content of the word dictionary 1723. Concerning “presence attribute”, the registered content of the word dictionary 1723 is given priority.

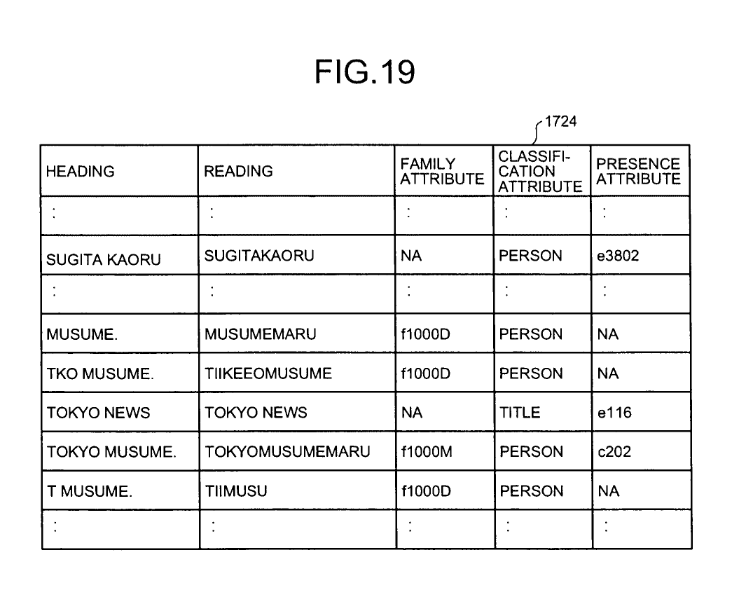

When the word dictionary 1724 shown in FIG. 13 is used, items including “reading” are merged with the word dictionary 1724 to update the content of the word dictionary 1724. For example, the word dictionary 1724 is in a state shown in FIG. 18. The word-dictionary registering unit 41 compares the word dictionary master 51 shown in FIG. 17 and the word dictionary 1724 shown in FIG. 18 and adds a difference between the word dictionary master 51 and the word dictionary 1724 to the word dictionary 1724 or changes the word dictionary 1724 to update the word dictionary 1724 to a state shown in FIG. 19.

When words are extracted from the content-information storing unit 1711 and the content-material storing unit 1712 by the morphological analysis, the word-dictionary registering unit 41 updates “presence attribute” in a character string representing a location of presence of a word coinciding with a word, “presence attribute” of which is “NA” in the word dictionary 1723 (or the word dictionary 1724).

The internet connecting unit 42 is a functional unit that acquires, through the communication unit 16, information from an external apparatus connected to the network N. Specifically, the Internet connecting unit 42 acquires, according to an instruction from the word-dictionary registering unit 41, the word dictionary master 51 from the word dictionary master server 50 connected to the network N.

As described above, according to the third embodiment, even when one keyword is input as a retrieval object by the user, a word tied to the keyword can be included in the retrieval object based on family attributes of the words registered in the word dictionary. Therefore, it is possible to efficiently retrieve contents related to a name represented by the keyword and an alias of the name and improve convenience for the user.

According to this embodiment, the word dictionary 1723 can be updated based on the word dictionary master 51 acquired from the word dictionary master server 50. Therefore, it is possible to follow a change in a word, a pronunciation and a name of which change according to the current of the times.

Timing when the word-dictionary registering unit 41 acquires the word dictionary master 51 from the word dictionary master server 50 can be any timing. However, it is preferable to acquire the word dictionary master 51 at every predetermined time interval such as once a day.

Next, a retrieving apparatus according to a fourth embodiment of the present invention is explained. Components same as those in the first, second, and third embodiments are denoted by the same reference numerals and signs and explanation of the component is omitted.

In the third embodiment, the word dictionary 1723 (or the word dictionary 1724) is updated with the word dictionary master 51 provided by the word dictionary master server 5. In the retrieving apparatus 4 according to the fourth embodiment, the retrieving apparatus 4 itself specifies a family relation among words included in content stored in the content storing unit 171 and updates the word dictionary 1723 (or the word dictionary 1724).

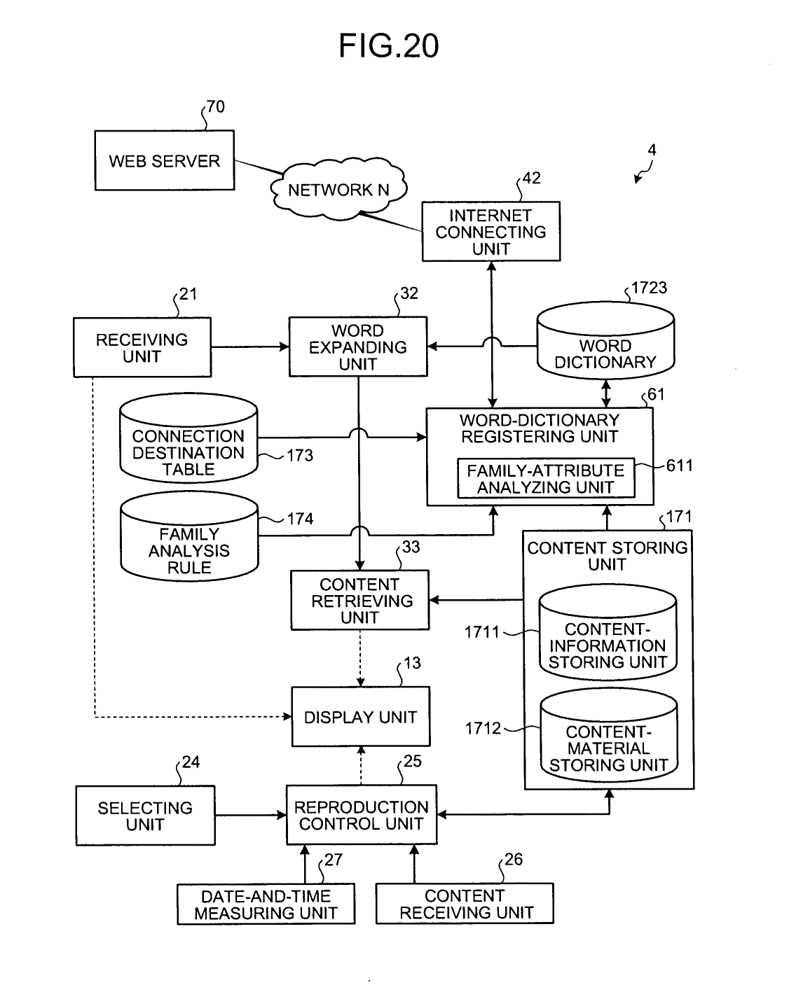

Referring to FIG. 20, respective functional units of the retrieving apparatus 4 realized by cooperation of the CPU 11 and the programs stored in the ROM 14 or the storing unit 17 are explained. FIG. 20 is a block diagram illustrating the functional structure of the retrieving apparatus 4 according to the fourth embodiment.

As shown in FIG. 20, the retrieving apparatus 4 includes a word-dictionary registering unit 61 in addition to the receiving unit 21, the selecting unit 24, the reproduction control unit 25, the content receiving unit 26, the date-and-time measuring unit 27, the word expanding unit 32, the content retrieving unit 33, and the Internet connecting unit 42 described above. The storing unit 17 stores a connection destination table 173 and a family analysis rule 174 described later in advance. The retrieving apparatus 4 and a Web server 70 are connected to be capable of communicating with each other through the network N such as the Internet.

The Web server 70 is a Web server that can provide an external apparatus with information and is an information resource present on the network N. Specifically, the Web server 70 provides, in response to a request from the retrieving apparatus 4, the external apparatus (the retrieving apparatus 4) with a Web page (not shown) such as an HTML file stored in the Web server 70 itself or dynamically created. The number of Web servers 70 connected to the network N is not specifically limited.

The word-dictionary registering unit 61 has functions same as those of the word-dictionary registering unit 31. The word-dictionary registering unit 61 acquires, based on a word extracted from contents of the content-information storing unit 1711 and the content-material storing unit 1712, a Web page related to the word from the Web server 70 through the Internet connecting unit 42.

Among Web sites, there is a site called consumer generated media (CGN) for a large number of users to share knowledge. In such a Web site, in general, knowledge specialized for a service field is often shared. Therefore, it is possible to improve accuracy of retrieval by setting in advance a Web site (a uniform resource locator (URL) of the Web server 70) as a connection destination for each of fields of words to be retrieved.

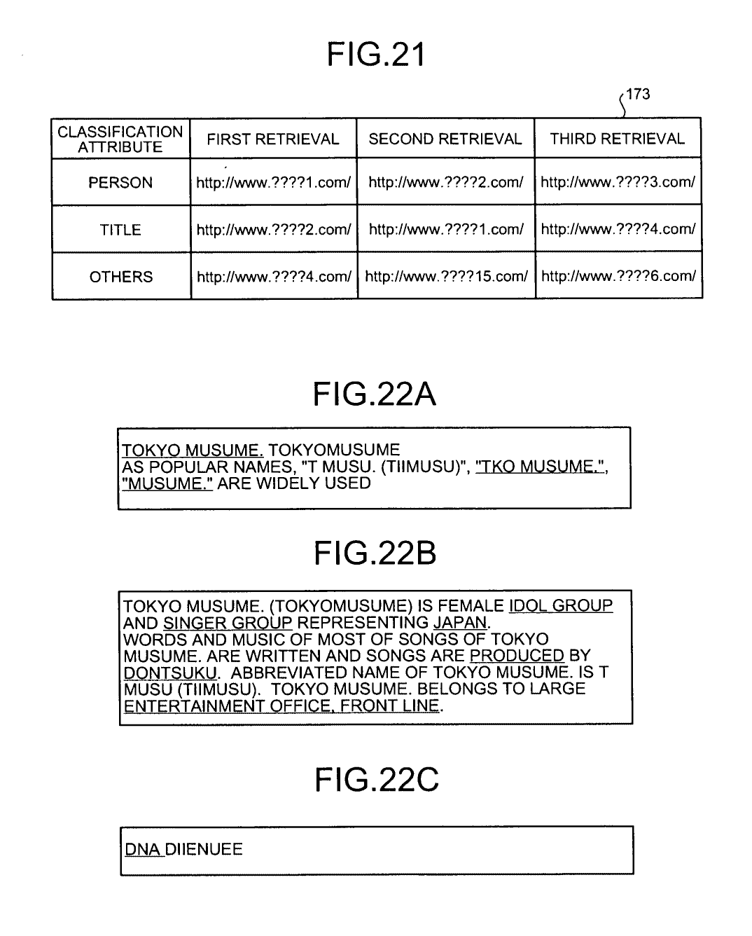

FIG. 21 is a diagram illustrating an example of the connection destination table 173 in which a URL of the Web server 70 as a connection destination is set according to a field of a retrieval object word. In the figure, “classification attribute” corresponds to “classification attribute” included in the word dictionary 1723 and the like. For each of fields, URLs of the Web server 70 as three connection destinations for first retrieval to third retrieval are registered. By storing such a connection destination table 173 in the storing unit 17 in advance, it is possible to properly use the Web server 70 as a connection destination for each of fields of words to be retrieved.

When the connection destination table 173 is used, the word-dictionary registering unit 61 refers to, in the connection destination table 173, a URL corresponding to “classification attribute” of a word registered in the word dictionary 1723 and makes connection to the Web server 70 having the URL to perform retrieval of a Web page related to the word. For example, concerning “Tokyo Musume.”, it is possible to obtain retrieval results (Web pages) shown in FIGS. 22A and 22B. Concerning an abbreviated word such as “DNA”, it is possible to obtain a retrieval result shown in FIG. 22C.

It is preferable that retrieval by the word-dictionary registering unit 61 is performed only for words, “family attribute” of which is “NA”. When the Web server 70 as a connection destination is a retrieval site, the word-dictionary registering unit 61 transmits a retrieval object word (e.g., Tokyo Musume.) as a retrieval key.

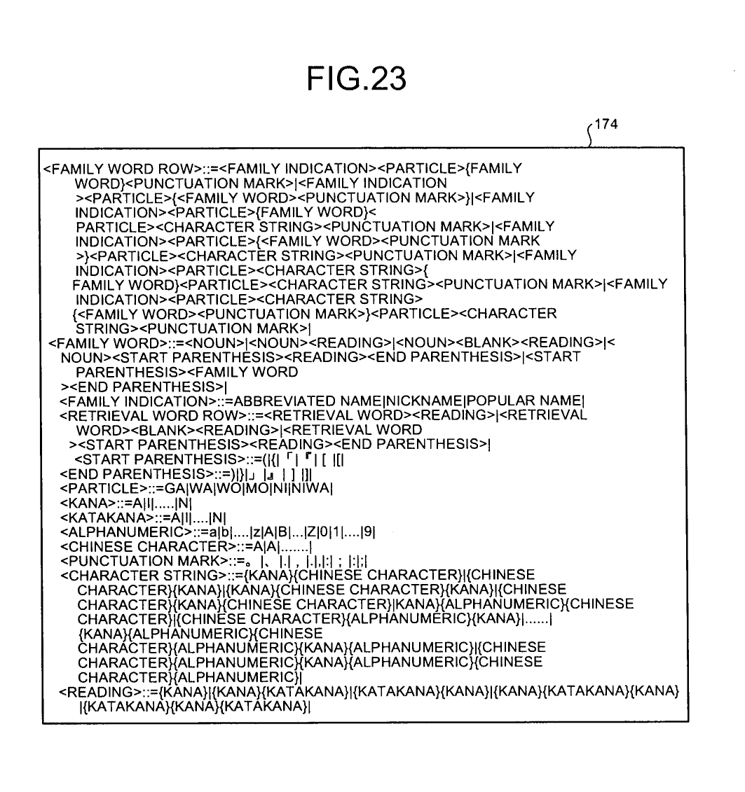

The word-dictionary registering unit 61 has a family-attribute analyzing unit 611. The family-attribute analyzing unit 611 analyzes a retrieval result (a Web page) obtained from the Web server 70 using, for example, the family analysis rule 174 shown in FIG. 23 and extracts a word tied to the retrieval object word and a reading of the word.

The family analysis rule 174 shown in FIG. 23 is called a Backus-Naur form (BNF) and is written according to a normal notation for describing syntax. Because an actual Web page is described in HTML, a family analysis rule also including tags of HTML should be described. However, in the family analysis rule shown in the figure, parts related to description in HTML are omitted for simplification of explanation.

In the Backus-Naur form, a character string between “<” and “>” is called a component. “::=” indicates that a component on a left side thereof is formed by a character string on a right side thereof. For example, “<alphanumeric character>” indicates that the component is formed by any one of alphabets from “a” to “z”, alphabets from “A” to “Z”, and numbers from “0” to “9”. “|” indicates a meaning “or”.

In FIG. 23, a component “family word row” is formed by a family indication word (an abbreviated name, a nickname, or a popular name), a particle (ga, wa, wo, mo, ni, or niwa), and a family word. Referring to an example shown in FIG. 22A, specifically, “Tokyo Musume.” on a first row is a noun and is a retrieval word (Tokyo Musume.) itself. This word matches “<retrieval word>”<reading>” of a description “<retrieval word row>::=<retrieval word><reading>|<retrieval word><blank><reading>|1<retrieval word><start parenthesis><reading><end parenthesis>|” of the rule shown in FIG. 23. Therefore, it is seen that <reading> of “Tokyo Musume.” is “tokyomusume”.

A second row shown in FIG. 22A matches “<family indication word><particle><character string>{family word}<particle><character string><punctuation mark>” of a description “<family word row>::=<family indication word><particle>{family word}<punctuation mark>|<family indication word><particle>{<family word><punctuation mark>}|<family indication word><particle>{family word}<particle><character string><punctuation mark>|<family indication word><particle>{<family word><punctuation mark>}<particle><character string><punctuation mark>|<family indication word><particle><character string>{family word}<particle><character string><punctuation mark>|<family indication word><particle><character string>{<family word><punctuation mark>}<particle><character string><punctuation mark>|” of the rule shown in FIG. 23.

In other words, the description is analyzed as “<family indication word>(popular name)+<particle>(wa)+<character string>(mainly)+(start parenthesis) (” “+<family word>(T Musu.)+<reading>(<start parenthesis<(( )+<reading>(tiimusu)+<end parenthesis>( ))+<end parenthesis>(″)+<start parenthesis>(″)+<family word>(TKO Musume.)+<end parenthesis>(″)+<start parenthesis>(″)+<family word>(Musume.)+<end parenthesis>(″)+<particle>(ga)+<character string>(widely used)+<punctuation mark>(.)”. The character strings between “(” and “)” represent respective character strings on the second row shown in FIG. 22A.

“T Musu.”, “TKO Musume.”, and “Musume.” are extracted as family words of “Tokyo Musume.”. “tiimusu” corresponding to “T Musu.” is extracted as a reading of the family word.

The family-attribute analyzing unit 611 registers a family word extracted from a Web page by analysis using the family analysis rule 174 and a reading of the family word in the word dictionary 1723 (or the word dictionary 1724). The family-attribute analyzing unit 611 gives the same family information to family words having a common word as the origin of a word. When a word as the origin of a word is unknown, only family information can be given without including “D” or “M” in a family attribute.

The family-attribute analyzing unit 611 can register a URL of the Web server 70 as an extraction destination of a family word as well in the word dictionary 1723 (or 1724).

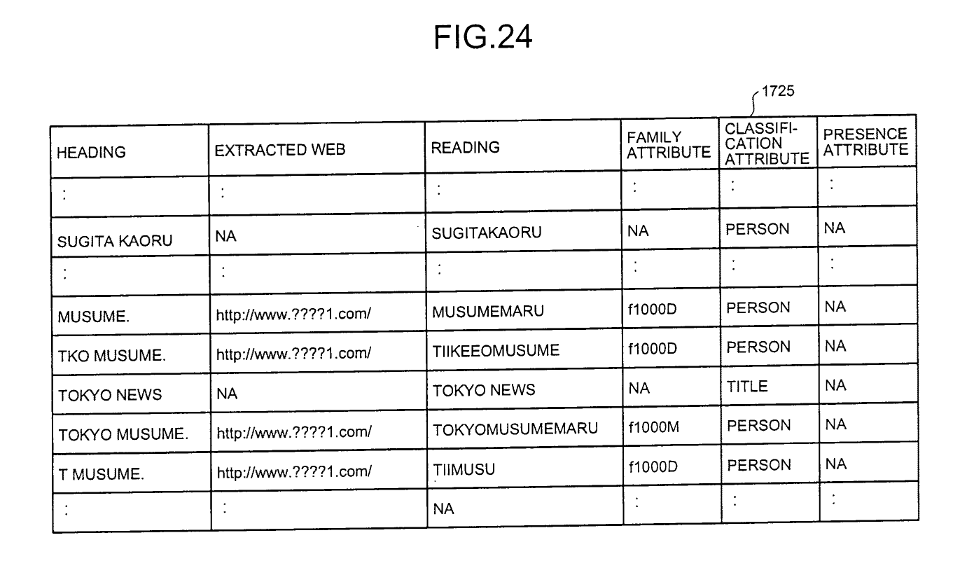

FIG. 24 is a diagram illustrating another example of the word dictionary 1724 in which the URL of the Web server 70 as the extraction destination of the family word is registered as well. As shown in FIG. 24, in the word dictionary 1725, for each of headings of respective words, “extracted Web”, “reading”, “family attribute”, “classification attribute”, and “presence attribute” of the word are registered in association with one another. The URL of the Web server 70 as the extraction destination of the family word is registered in the item of “extracted Web”. When a relevant URL is not present, “NA” meaning that a relevant URL is not present is registered.

As described above, according to the fourth embodiment, even when a keyword is input by the user as a retrieval object, a word tied to a keyword input by speech can be included in the retrieval object based on family attributes of respective words registered in the word dictionary. Therefore, it is possible to efficiently retrieve contents related to a name represented by the keyword and an alias of the name and improve convenience for the user.

According to this embodiment, the retrieving apparatus 4 itself can specify a family relation among words included in content stored in the content storing unit 171 and update the word dictionary 1723. Therefore, it is possible to follow a change in a word, a pronunciation and a name of which change according to the current of the times.

In the example explained in this embodiment, the rules shown in FIG. 23 are used as the family analysis rule. However, content of the family analysis rule is not limited to this example. For example, a description employing tags in electronic program guide data (EPG) and tags of HTML is also possible. The number of characters of a family word tends to be smaller than that of a formal name. Therefore, it is also possible to define limitation concerning the number of characters such as “the number of characters of a family word<the number of characters of a formal name”.

Concerning a reading, the number of characters of the reading does not exceed the number of characters of a reading appended by the morphological analysis. Therefore, it is also possible to define limitation concerning the number of characters such as “the number of characters of an extracted reading<the number of characters of a reading by the morphological analysis”.

The first to fourth embodiments have been explained. However, the present invention is not limited to the embodiments. Various modifications, replacements, additions, and the like are possible without departing from the spirit of the present invention.

A program executed by the retrieving apparatuses according to the embodiments is incorporated in the ROM 14, the storing unit 17, and the like in advance and provided. However, the present invention is not limited to this. The program can be recorded in computer-readable recording media such as a CD-ROM, a flexible disk (FD), a compact disk-recordable (CD-R), and a digital versatile disk (DVD) as a file of an installable format or an executable format and provided. The program can be stored on a computer connected to a network such as the Internet and downloaded through the network to be provided or can be provided or distributed through the network such as the Internet.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A retrieving apparatus comprising:
a first storing unit that stores a content;
a second storing unit that stores a word dictionary in which a plurality of words are registered and each of the words representing a formal name and an abbreviated name of the formal name is registered in association with a family attribute indicating a family relation among the words;
a receiving unit that receives an input of a keyword as a retrieval object;
a word expanding unit that reads out a word coinciding with the keyword and a word familiar with the word from the word dictionary; and
a retrieving unit that retrieves a content related to any one of the words read out by the word expanding unit, from the first storing unit.

2. The apparatus according to claim 1, further comprising:
a registering unit that registers each of the words extracted from the content and a presence attribute indicating a storage location of the content including the each of the words in association with the word dictionary, wherein
the retrieving unit retrieves a word associated with the presence attribute among the words read out by the word expanding unit, from the storage location indicated by the presence attribute.

3. The apparatus according to claim 2, further comprising:
an external communication unit that acquires related information related to a registered word registered in the word dictionary from information resources present on a network; and
an extracting unit that extracts a word that is in a family relation with the registered words from a character string included in the related information, wherein
the registering unit registers the word extracted by the extracting unit in the word dictionary in association with a family attribute indicating the family relation with the registered word.

4. The apparatus according to claim 3, wherein
the extracting unit extracts a reading of the word that is in the family relation with the registered word from the character string included in the related information, and
the registering unit registers the reading of the word extracted by the extracting unit in the word dictionary in association with a word corresponding to the reading.

5. The apparatus according to claim 3, further comprising:
a third storing unit that stores a connection destination table in which a field of an object represented by each of the words and a presence location of the information resources corresponding to the field are associated with each other, wherein
the external communication unit acquires the related information from the presence location of the information resources corresponding to the field of the object represented by the registered word, based on the connection destination table.

6. The apparatus according to claim 1, wherein
the first storing unit stores, as the content, a content material reproducible constantly and content information describing information concerning content reproducible at predetermined date and time, and
the retrieving unit retrieves content including any one of words read out by the word expanding unit from the first storing unit.

7. A retrieving method comprising:
receiving an input of a keyword as a retrieval object;
reading out a word coinciding with the keyword and a word familiar with the word from a word dictionary, the word dictionary registering a plurality of words and each of the words representing a formal name and an abbreviated name of the formal name in association with a family attribute indicating a family relation among the words; and
retrieving a content related to any one of the words read out in the reading out.

8. A computer program product having a computer readable medium including programmed instructions for retrieving a content, wherein the instructions, when executed by a computer, cause the computer to perform:
receiving an input of a keyword as a retrieval object;
reading out a word coinciding with the keyword and a word familiar with the word from a word dictionary, the word dictionary registering a plurality of words and each of the words representing a formal name and an abbreviated name of the formal name in association with a family attribute indicating a family relation among the words; and
retrieving a content related to any one of the words read out in the reading out.
